(19) United States
(12) Patent Application Publication
(10) Pub. No.: US 2016/0057463 A1
(43) Pub. Date: Feb. 25, 2016

(54) HYBRID TIME-DIVISIONAL MULTIPLEXED MODULATION

(71) Applicant: GATESAIR, INC., Mason, OH (US)

(72) Inventors: Stefan Ilsen, Braunschweig (DE); Frieder Juretzek, Braunschweig (DE)

(21) Appl. No.: 14/484,078

(22) Filed: Sep. 11, 2014

Related U.S. Application Data
(60) Provisional application No. 62/039,293, filed on Aug. 19, 2014.

(51) Int. Cl. H04N 21/236; H04N 21/414; H04N 7/08; H04N 21/845; H04N 21/2381; H04N 21/2389; H04N 21/242; H04J 3/16; H04N 7/54

(52) U.S. Cl. CPC H04N 21/23614; H04J 3/16; H04N 21/41407; H04N 7/08; H04N 7/54; H04N 21/2381; H04N 21/23892; H04N 21/242; H04N 21/8456

(57) ABSTRACT

Systems and methods are provided for generating a hybrid signal. Digital video is broadcast in a first set of at least one time slot of a plurality of time slots comprising the hybrid signal. Mobile data, formatted for reception at a mobile device, is broadcast in a second set of at least one time slot of the plurality of time slots comprising the hybrid signal. Structured data is broadcast in a transition band between the first set of at least one time slot and the second set of at least one time slot.

### RELATED APPLICATIONS

This application claims the benefit of the earlier filing date of U.S. Provisional Patent Application No. 62/039,293 filed Aug. 19, 2014. The disclosure in the aforementioned U.S. Provisional Patent Application No. 62/039,293 is hereby incorporated herein in its entirety by this reference thereto.

### TECHNICAL FIELD

The present invention relates to an apparatus and method for broadcasting radio frequency signals, and more specifically, to a hybrid time-divisional multiplexing modulation schema.

### BACKGROUND OF THE INVENTION

A wireless system, such as a digital video broadcasting system, may transmit data in the form of a sequence of frames arranged in a frame structure. For example, a digital video broadcasting system can utilize any of a Digital Video Broadcasting (DVB) standard, an Advanced Televisions Systems Committee (ATSC) standard, an Integrated Services Digital Broadcasting (ISDB) standard, or Digital Multimedia Broadcasting (DMB) standard. Each frame typically includes a preamble section and a data section. The preamble section and the data section are time-multiplexed.

### SUMMARY OF THE INVENTION

In accordance with one aspect of the present invention, a method is provided for generating a hybrid signal. Digital video is broadcast in a first set of at least one time slot of a plurality of time slots comprising the hybrid signal. Mobile data, formatted for reception at a mobile device, is broadcast in a second set of at least one time slot of the plurality of time slots comprising the hybrid signal. Structured data is broadcast in a transition band between the first set of at least one time slot and the second set of at least one time slot.

In accordance with another aspect of the present invention, a hybrid modulator system is provided. A digital video source is configured to provide digital video according to a desired video standard. A mobile data source is configured to provide data formatted for reception at a mobile device. A structured data source is configured to provide structured data. A multiplexer is configured to combine the digital video, the data formatted for reception at the mobile device, and the structured data as a hybrid signal in a time-multiplexed arrangement. In the hybrid signal, the digital video occupies a first set of at least one time slot of a plurality of time slots comprising the hybrid signal; the data formatted for reception at the mobile device occupies a second set of at least one time slot of the plurality of time slots comprising the hybrid signal, and the structured data occupies a transition band between the first set of at least one time slot and the second set of at least one time slot.

In an embodiment of the present invention, a hybrid modulator system is provided. A digital video source is configured to provide digital video formatted according to the Digital Video Broadcasting (DVB) standard. A mobile data source is configured to provide mobile data formatted according to the Long Term Evolution (LTE) standard. A structured data source is configured to provide structured data. A multiplexer is configured to insert the mobile data into a future extension frame associated with the DVB standard and to insert the structured data in a sync buffer time associated with the future extension frame.

### BRIEF DESCRIPTION OF THE DRAWINGS

For a better understanding of the invention, reference may be made to the accompanying drawings, in which:

FIG. 1 illustrates a hybrid modulator system for generating a hybrid signal in accordance with an aspect of the present invention;

FIG. 2 illustrates one implementation of a system in accordance with an aspect of the present invention;

FIG. 3 illustrates a portion of a DVB-T2 superframe containing the combined digital signal in a first implementation;

FIG. 4 illustrates a portion of a DVB-T2 superframe containing the combined digital signal in a second implementation; and

FIG. 5 illustrates a method for generating a hybrid signal in accordance with an aspect of the present invention.

### DESCRIPTION OF EMBODIMENTS

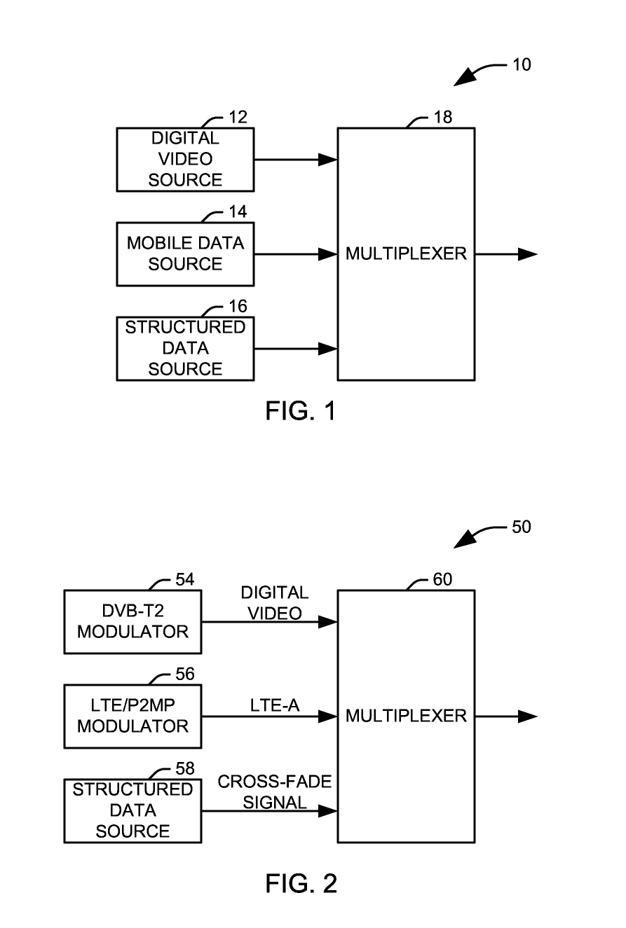

FIG. 1 illustrates a hybrid modulator system 10 for generating a hybrid signal in accordance with an aspect of the present invention. The system 10 includes a digital video source 12 configured to provide digital video according to a desired video standard. In one implementation, the digital video is provided according to the Digital Video Broadcasting-Terrestrial 2 (DVB-T2) standard as plurality of digital video streams multiplexed into a single digital stream via Coded Orthogonal Frequency Divisional Multiplexing (COFDM). A mobile data source 14 provides mobile data, that is, data formatted for reception at a mobile device. For example, the mobile data source 14 can be formatted according to the Long-Term Evolution (LTE) standard. It will be appreciated that the mobile data source 14 can be an intermediary source of the data, for example, as one cell within in a network of towers broadcasting mobile signals.

In accordance with an aspect of the present invention, the hybrid modulator system 16 further includes a structured data source that provides structured data for addition to the hybrid signal, for example, in a transition band between the digital video and the mobile data. In one implementation, the structured data source 16 can provide a digital stream of structured data selected to improve at least one signal metric associated with the hybrid signal, such as a peak-to-average ratio. For example, the structured data can include a waveform selected to allow a smooth transition between a first waveform representing the digital video and a second waveform representing the data formatted for reception at a mobile device, band-limited noise having an amplitude limit selected to prevent output power fluctuation, or a signal modulated with only a repeated binary value. In another implementation, the structured data is a signal modulated to carry data other than that of the digital video and the mobile data.

A multiplexer 18 combines the digital video, the mobile data, and the structured data into a hybrid signal. Specifically, the multiplexer 18 is configured to combine the digital video, the data formatted for reception at the mobile device, and the structured data as a hybrid signal in a time-multiplexed arrangement. In this arrangement, the digital video occupies a first set of at least one time slot of a plurality of time slots comprising the hybrid signal; the data formatted for reception at the mobile device occupies a second set of at least one time slot of the plurality of time slots comprising the hybrid signal, and the structured data occupies a transition band between the first set of at least one time slot and the second set of at least one time slot.

In one implementation, the system can be applied in a tower overlay arrangement to provide mobile data in combination with terrestrial broadcasting. Some terrestrial broadcasting standards provide frame structures with slots for carrying video, as well additional slots for other data. For example, the DVB Terrestrial 2^{nd} generation (DVB-T2) standard for terrestrial standard broadcasting has a super frame structure consisting of a number of frames. A slot, included in the super frame or each frame, does not transmit a DVB-T2 signal. The super frame is referred to as a Future Extension Frame (FEF), and, FEF slots may be provided in addition to the parts of the frame structure which transmit video signals intended for reception by conventional DVB receivers. These additional physical slots, such as the FEF slots, can be used for the transmission of signals, such as, for example, signals intended for reception by handheld receivers. The standard includes a period in which no signal is transmitted, referred to as a “sync buffer time” or “black spot” between the video data and the mobile data.

In the illustrated system, the structured data source 16 can be used to fill the sync buffer time with structured data selected to improve signal properties, such as band-limited noise, modulated zero values, or a waveform selected to smooth the transition between the video data and the mobile data. In another implementation, the sync buffer time could be provide a tertiary transmission, such as data supplementing the video or mobile data, audio, or another signal suitable for transmission within the sync buffer time window.

FIG. 2 illustrates one implementation of a hybrid modulator system 50 in accordance with an aspect of the present invention. In the illustrated implementation, the system 50 is implemented as part of a tower overlay system providing both DVB-T2 terrestrial video transmission and Long-Term Evolution-Advanced (LTE-A) or LTE-A+ data for mobile devices. Accordingly, the system includes a DVB-T2 modulator 54, a Long-Term Evolution/Point-to-Multipoint (LTE/P2MP) modulator 56, and a structured data source 58. In the illustrated system, the structured data source 58 provides a waveform enabling a cross fade between the DVB-T2 data and the LTE-A data. It will be appreciated, however, that other forms of structured data can be used, including a series of zeros, band-limited noise, or a tertiary transmission, such as audio or an additional data stream.

The data from each of the DVB-T2 modulator 54, the LTE/P2MP modulator 56, and the structured data source 58 are provided to a multiplexer 60 to combine the data into a single digital signal compliant with the DVB-T2 standard. FIG. 3 illustrates a portion of a DVB-T2 superframe 80 containing the combined digital signal in a first implementation. It will be appreciated that the illustrated portion of the superframe 80 is provided for the purpose of example and the illustrated time slots are not shown to scale. The illustrated portion of the superframe 80 includes a first T2 frame 82, a future extension frame (FEF) 84, and a second T2 frame 86. Each T2 frame 82 and 86 contains at least a preamble (P1) 88 and 89 and a block of T2 data 91 and 92. In the illustrated implementation, the LTE-A data 94 is inserted into the future extension frame 84, and the cross-fade waveform 95 is inserted into a sync buffer time 96 between a preamble (P1) 97 of the future extension frame and the LTE-A data 98. Accordingly a smooth transition can be realized between the T2 video data 91 and the LTA-mobile data 98.

In another implementation, the sync buffer time can be split to occupy two non-contiguous locations in the future extension frame. FIG. 4 illustrates a portion of a DVB-T2 superframe 100 containing the combined digital signal in this implementation. It will be appreciated that the illustrated portion of the superframe 100 is provided for the purpose of example and the illustrated time slots are not shown to scale. The illustrated portion of the superframe 100 includes a first T2 frame 102, a future extension frame (FEF) 104, and a second T2 frame 106. Each T2 frame 102 and 106 contains at least a preamble (P1) 108 and 109 and a block of T2 data 110 and 111. In the illustrated implementation, the LTE-A data 113 is inserted into the future extension frame 104, and a first cross-fade waveform 114 is inserted into a first sync buffer time 115 between a preamble (P1) 116 of the future extension frame 104 and the LTE-A data 113. A second cross-fade waveform 118 is inserted into a second sync buffer time 119 between the LTE-A data 117 and the second T2 frame 106. It will be appreciated that the first cross-fade waveform 114 and the second cross-fade waveform 118 can differ, with the first cross-fade waveform 114 providing a transition between the T2 data 110 and the LTE-A data 117 and the second cross-fade waveform 118 providing a transition between the LTE-A data 117 and the T2 data 111. Through use of the split sync buffer time windows, a smooth transition can be assured on both ends of the future extension frame 104.

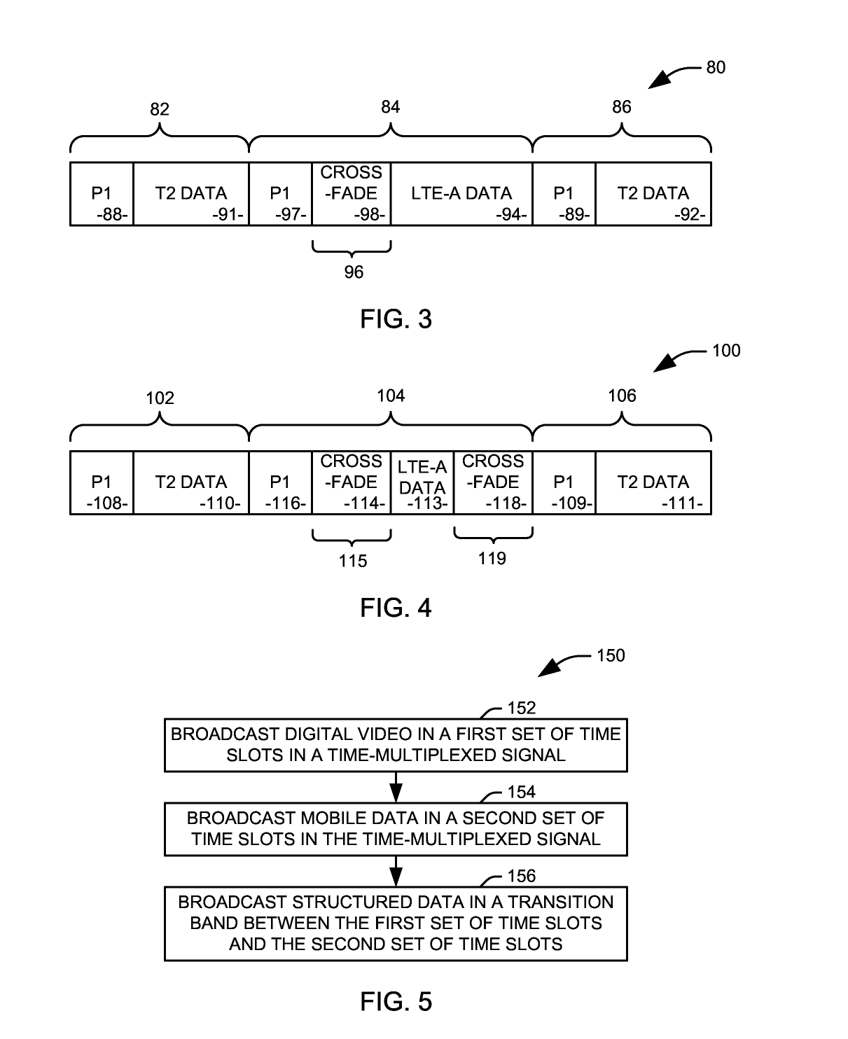

In view of the foregoing structural and functional features described above, a method in accordance with various aspects of the present invention will be better appreciated with reference to FIG. 5. While, for purposes of simplicity of explanation, the method of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a method in accordance with an aspect the present invention.

FIG. 5 illustrates a method 150 for generating a hybrid signal in accordance with an aspect of the present invention. At 152, digital video is broadcast in a first set of at least one time slot of a plurality of time slots comprising the hybrid signal. In one implementation, this includes broadcasting digital video compliant with the DVB-T2 standard in a T2 slot associated with the DVB-T2 standard. At 154, mobile data, formatted for reception at a mobile device, is broadcast in a second set of at least one time slot of the plurality of time slots comprising the hybrid signal. For example, the mobile data can be formatted to compliant with a long term evolution (LTE) standard, such as LTE-A, and broadcast within a future extension frame associated with the DVB-T2 standard.

At 156, structured data is broadcast in a transition band between the first set of at least one time slot and the second set of at least one time slot. For example, the structured data can be broadcast in a sync buffer time associated with the future extension frame of the DVB-T2 standard. In one implementation, the structured data is selected to improve a quality metric of the hybrid signal. For example, the structured data can include a waveform selected to allow a smooth transition between a first waveform representing the digital video and a second waveform representing the data formatted for reception at a mobile device, such as a cross-fade between the first waveform and the second waveform. Alternatively, the structured data can include band-limited noise having an amplitude limit selected to prevent output power fluctuation or a signal modulated to carry only a repeated binary value. Alternatively, the structured data can include a signal modulated to carry data from a data source other than the digital video and the data formatted for reception at a mobile device.

In one implementation, the structured data can be included not only in the transition between the digital video and the mobile data, but also in the transition from the mobile data to the digital video. In such an implementation, digital video can be broadcast in a third set of at least one time slot, such as the video data in a new frame, and the structured data can be broadcast in a transition band between the second set of at least one time slot and the third set of at least one time slot. In the example of a DVB-T2/LTE-A hybrid signal, the sync buffer time associated with the future extension frame can be split into a first sync buffer time, located near a beginning of the future extension frame, and a second sync buffer time, located near an end of the future extension frame, with the structured data broadcast in each of the first and second sync buffer times.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

Having described the invention, we claim:

1. A method for generating a hybrid signal comprising:
broadcasting digital video in a first set of at least one time slot of a plurality of time slots comprising the hybrid signal;
broadcasting data, formatted for reception at a mobile device, in a second set of at least one time slot of the plurality of time slots comprising the hybrid signal; and
broadcasting structured data in a transition band between the first set of at least one time slot and the second set of at least one time slot.

2. The method of claim 1, wherein the structured data is selected to improve a quality metric of the hybrid signal.

3. The method of claim 2, wherein the structured data comprises a waveform selected to allow a smooth transition between a first waveform representing the digital video and a second waveform representing the data formatted for reception at a mobile device.

4. The method of claim 3, wherein the selected waveform is a cross-fade between the first waveform and the second waveform.

5. The method of claim 2, wherein the structured data comprises band-limited noise having an amplitude limit selected to prevent output power fluctuation.

6. The method of claim 2, wherein the structured data comprises a signal modulated with only a repeated binary value. s 7. The method of claim 2, wherein the structured data comprises a signal carrying data from a data source other than the digital video and the data formatted for reception at a mobile device.

8. The method of claim 1, wherein broadcasting digital video comprises broadcasting digital video compliant with the DVB-T2 standard and broadcasting data formatted for reception at a mobile device comprising broadcasting data compliant with a long term evolution (LTE) standard.

9. The method of claim 8, wherein broadcasting digital video compliant with the DVB-T2 standard comprises broadcasting the digital video in a T2 frame and broadcasting data compliant with a long term evolution (LTE) standard comprises broadcasting the LTE data in a future extension frame, and broadcasting structured data in the transition band comprises broadcasting the structured data in a sync buffer time associated with the future extension frame.

10. The method of claim 9, wherein the sync buffer time associated with the future extension frame includes a first sync buffer time, located near a beginning of the future extension frame, and a second sync buffer time, located near an end of the future extension frame, and broadcasting the structured data in a sync buffer time associated with the future extension frame comprising broadcasting the structured data in the first and second sync buffer times.

11. The method of claim 1, further comprising:
broadcasting digital video in a third set of at least one time slot of a plurality of time slots comprising the hybrid signal; and
broadcasting structured data in a transition band between the second set of at least one time slot and the third set of at least one time slot.

12. A hybrid modulator system comprising:
a digital video source configured to provide digital video according to a desired video standard;
a mobile data source configured to provide data formatted for reception at a mobile device;
a structured data source configured to provide structured data; and
a multiplexer configured to combine the digital video, the data formatted for reception at the mobile device, and the structured data as a hybrid signal in a time-multiplexed arrangement, such that the digital video occupies a first set of at least one time slot of a plurality of time slots comprising the hybrid signal; the data formatted for reception at the mobile device occupies a second set of at least one time slot of the plurality of time slots comprising the hybrid signal, and the structured data occupies a transition band between the first set of at least one time slot and the second set of at least one time slot.

13. The hybrid modulator system of claim 12, wherein the structured data comprises a waveform selected to allow a smooth transition between a first waveform representing the digital video and a second waveform representing the data formatted for reception at a mobile device.

14. The hybrid modulator system of claim 12, wherein the structured data comprises band-limited noise having an amplitude limit selected to prevent output power fluctuation.

15. The hybrid modulator system of claim 12, wherein the structured data comprises a signal modulated with only a repeated binary value.

16. The hybrid modulator system of claim 12, wherein the structured data comprises a signal carrying data other than the digital video and the data formatted for reception at a mobile device.

17. A hybrid modulator system comprising:
a digital video source configured to provide digital video formatted according to the Digital Video Broadcasting (DVB) standard;
a mobile data source configured to provide mobile data formatted according to the Long Term Evolution (LTE) standard;
a structured data source configured to provide structured data; and
a multiplexer configured to insert the mobile data into a future extension frame associated with the DVB standard and to insert the structured data in a sync buffer time associated with the future extension frame.

18. The hybrid modulator system of claim 17, wherein the multiplexer is configured to provide the sync buffer time associated with the future extension frame as a first sync buffer time, located near a beginning of the future extension frame and a second sync buffer time, located near an end of the future extension frame, and insert the structured data into each of the first and second sync buffer times.

19. The hybrid modulator system of claim 17, wherein the structured data is selected to improve a quality metric of the hybrid signal.

20. The hybrid modulator system of claim 17, comprises a signal carrying data other than the digital video and the mobile data.
